(19) United States
(12) Patent Application Publication
(10) Pub. No.: US 2018/0349303 A1
(43) Pub. Date: Dec. 6, 2018

(54) INPUT-OUTPUT SYSTEM, INPUT-OUTPUT PROGRAM INFORMATION PROCESSING APPARATUS AND CHAT SYSTEM

(71) Applicants: DeNA Co., Ltd., Tokyo (JP); Preferred Networks, Inc., Tokyo (JP)

(72) Inventors: Koichi HAMADA, Tokyo (JP); Kazuki FUJIKAWA, Tokyo (JP); Yuya UNNO, Tokyo (JP); Sosuke KOBAYAASHI, Tokyo (JP); Yuta KIKUCHI, Tokyo (JP)

(21) Appl. No.: 15/944,251

(22) Filed: Apr. 3, 2018

(30) Foreign Application Priority Data
Apr. 6, 2017 (JP) 2017-075879

(51) Int. Cl. G06F 13/20; G06N 3/08

(52) U.S. Cl. CPC G06F 13/20; G06N 3/08

(57) ABSTRACT

Provided is an input-output system.

An input-output system 100 includes an input-output operation part 110, and an input-output model having a character representation space constructed by a large-scale data set. When an input data and a character representation vector are input into the input-output operation part 110, an output data corresponding to the input data reflecting the characteristics corresponding to the character representation vector is output. Further, the input-output system 100 includes a character representation vector calculation part 120 which, when a character data set, which is a small-scale data set, is input, a character representation vector corresponding to the characteristics represented in the character data set is output by the input-output model and the character representation space fixed at the input-output operation part 110.

### TECHNICAL FIELD

This invention relates to an input-output system that outputs output data reflecting characteristics in response to input data.

### BACKGROUND ART

Recently, research and development on deep learning are actively carried out due to development of a libraries such as “Chainer” (http://chainer.org/) that facilitate implementation of a system using deep learning, and advancement in processing capacity of computers.

One field where research and development are active is a system for conversation based on conversation models constructed by deep learning (Chatbot, etc.). Particularly, research and development have been carried out on methods for reflecting “characteristics” such as details of utterance and characteristics in expression for enhancing humanity and entertaining features. For example, Non-Patent Publication 1 discloses a method of constructing a conversation model that can reflect characteristics using LSTM (Long Short-Term Memory).

### PRIOR ART PUBLICATION

### Non-Patent Publication

### [Non-Patent Publication 1]

Jiwei Li, Michel Galley, Chris Brockett, Jianfeng Gao, and Bill Dolan. “A Persona-Based Neural Conversation Model”, ACL 2016.

### SUMMARY OF THE INVENTION

### Problem to be Solved by the Invention

In the technique disclosed in Non-Patent Publication 1, however, a conversation reflecting characteristics was possible only for the characters existed in learning data used in constructing a conversation model. If there was a demand to add a new character to the conversation model that does not exist in teacher data, it was necessary to add a conversation set data representing the new character to the learning data, and to reconstruct the entire conversation model. Normally, to construct a conversation model using a sufficient amount of data, several days to around one week are required in view of precision of conversation, etc. Therefore, there was a problem in difficulty to add a new character to a conversation model, considering the time and computational costs required for reconstructing the entire conversation model.

Taking the above into consideration, an object of this invention is to provide an input-output system, an input-output program, an information processing apparatus, and a chat system that can easily add a new character without reconstructing an input-output model.

### Means for Solving the Problem

### (Structure 1)

An input-output system including:

an input-output operation part,

where the input-output operation part includes an input-output model including a character representation space which is a space where characteristics, constructed by learning an input-output data set, are represented,

a character representation vector which is a vector representing characteristics in the character representation space and input data are input into the input-output operation part, and

the input-output operation part computes and outputs output data corresponding to the input data reflecting the characteristics based on the input-output model and the character representation space.

### (Structure 2)

The input-output system according to Structure 1, further including a character representation vector-calculation part,

a character data set which is an input-output data set for extracting characteristics is input into the character representation vector-calculation part, and

the character representation vector-calculation part calculates a character representation vector corresponding to the character data set based on a computed result on the character data set in the input-output model and the character representation space fixed in the input-output operation part.

### (Structure 3)

The input-output system according to Structure 1 or 2, in which:

input data and a plurality of character representation vectors are input into the input-output operation part,

the input-output operation part generates a character synthesis vector which is a vector where characteristics represented in each of the plurality of character representation vectors are synthesized, and computes and outputs output data corresponding to the input data reflecting characteristics synthesized based on the character synthesis vector.

### (Structure 4)

A chat system for performing a conversation reflecting characteristics between users,

where the chat system includes the input-output system according to any one of Structures 1 to 3,

the character representation vector based on a preset character is input into the input-output system, and

output data corresponding to input data from the user reflecting characteristics of the preset character is output.

### (Structure 5)

A chat system for performing a conversation reflecting characteristics between users,

the chat system including the input-output system according to Structure 2,

the character data set designated by the user is input into the input-output system, so that the character representation vector reflecting characteristics corresponding to the character data set is calculated, input data from the user and the character representation vector are input into the input-output operation part, and output data corresponding to the input data from the user is output.

### (Structure 6)

A chat system for performing a conversation reflecting characteristics between users,

the chat system including the input-output system according to Structure 3,

a plurality of character representation vectors based on a plurality of characters designated by the user is input into the input-output system, and

output data corresponding to input data from the user reflecting characteristics synthesizing the plurality of characters designated by the user is output.

### (Structure 7)

An information processing apparatus, including:

an input-output operation part including an input-output model including a character representation space which is a space where characteristics constructed by learning a first input-output data set is represented, and which computes and outputs output data corresponding to the input data reflecting the characteristics based on input data and a character representation vector which is a vector representing characteristics in the character representation space that is input; and

a character representation vector-calculation part into which a second input-output data set is input, and which calculates a character representation vector reflecting characteristics corresponding to the second input-output data set based on computed result in the input-output model and the character representation space fixed in the input-output operation part.

### (Structure 8)

An input-output program for executing, in an input-output system including an input-output operation part including an input-output model having a character representation space which is a space where characteristics constructed by learning an input-output data set are represented, the steps of:

inputting input data and a character representation vector which is a vector representing characteristics in the character representation space into the input-output operation part;

computing, by the input-output operation part, output data corresponding to the input data reflecting the characteristic based on the input-output model and the character representation space; and

outputting the output data.

### (Structure 9)

A data structure of a character used in an input-output system including an input-output operation part, including:

a character representation space which is a space representing characteristics constructed by learning an input-output data set,

where the data structure of a character is used for processing of the input-output operation part including an input-output model including the character representation space in which:

a character representation vector which is a vector representing characteristics in the character representation space and input data are input into the input-output operation part, and an output data corresponding to the input data reflecting the characteristics based on the input-output model and the character representation space is computed.

### Effect of the Invention

According to the input-output system, input-output program, information processing apparatus, and chat system of this invention, a new character can be added easily without reconstructing an input-output model.

### BRIEF DESCRIPTION OF THE DRAWINGS

FIG. 1 is a schematic view showing input-output relation on the input-output operation part 110 of the input-output system 100 in Embodiment 1.

FIG. 2 is a schematic view showing input-output relation on the character representation vector-calculation part 120 of the input-output system 100 in Embodiment 1.

FIG. 3A is a schematic view showing one example of an input-output model of Embodiment 1.

FIG. 3B is a schematic view showing one example of an input-output operation of the input-output operation part 110 of Embodiment 1.

FIG. 4 is a flow chart showing a schematic action of the character representation vector-calculation part 120 of Embodiment 1.

FIG. 5 shows an output example of the input-output operation part 110 when a particular character representation vector (Character 1) is input in Embodiment 1.

FIG. 6 shows an output example of the input-output operation part 110 when a particular character representation vector (Character 2) is input in Embodiment 1.

FIG. 7 shows an output example of the input-output operation part 110 when a synthesized character representation vector is input in Embodiment 1.

FIG. 8 shows an output example of the input-output operation part 110 when a synthesized character representation vector is input in Embodiment 1.

FIG. 9 shows an output example of the input-output operation part 110 when a synthesized character representation vector is input in Embodiment 1.

FIG. 10 is a schematic view showing the chat system 2 of Embodiment 2.

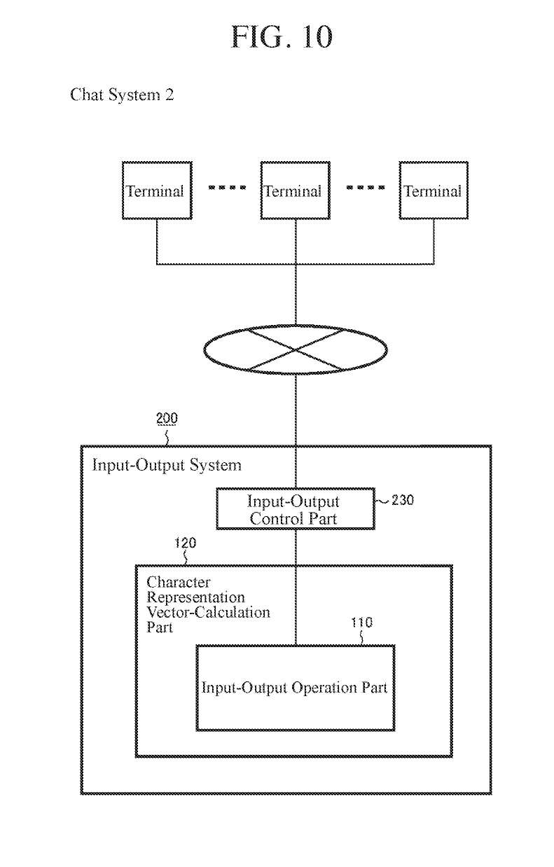

### EMBODIMENTS FOR CARRYING OUT THE INVENTION

The embodiments for carrying out this invention are explained below in accordance with the attached drawings.

### Embodiment 1

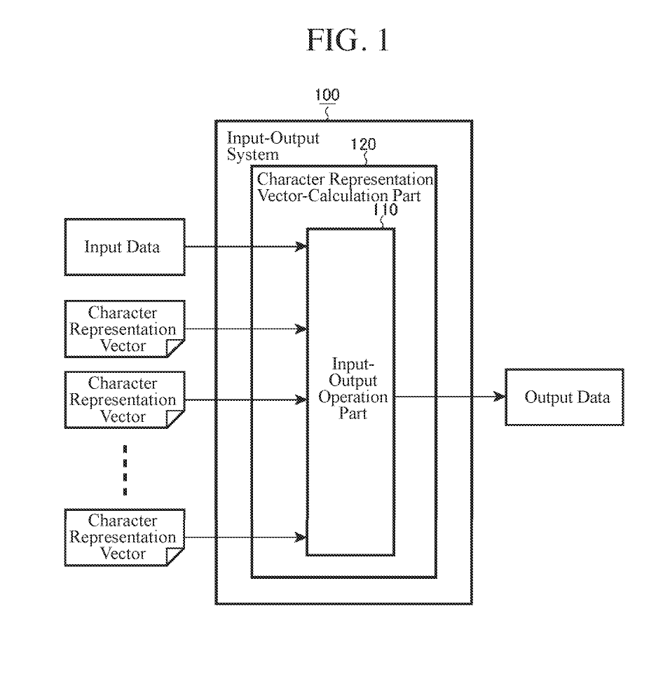

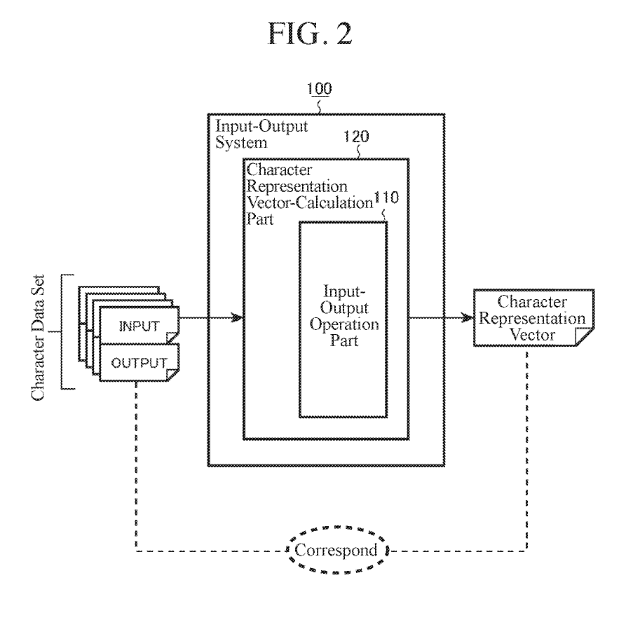

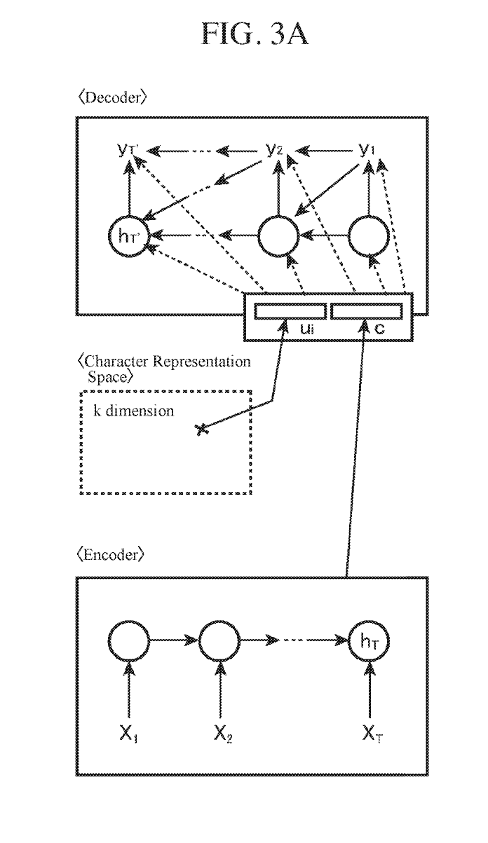

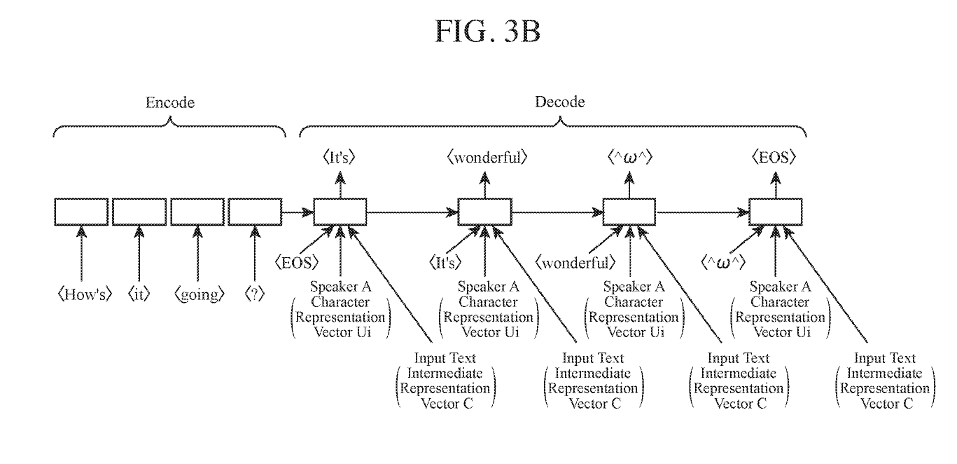

FIG. 1 to FIG. 3 are schematic structural views showing an input-output system of Embodiment 1 of this invention. FIG. 1 is a schematic view showing input-output relation on an input-output operation part 110. FIG. 2 is a schematic view showing input-output relation on a character representation vector-calculation part 120. FIG. 3A is a schematic view showing one example of an input-output model. Further, FIG. 3B is a schematic view showing one example of an input-output operation of the input-output operation part 110.

In this embodiment, the input-output system 100 is constructed by a computer, the system configured such that when a character representation vector (to be mentioned below) which is a vector representing characteristics is input together with input data, data reflecting characteristics is output, and includes the input-output operation part 110 and the character representation vector-calculation part 120.

There is no limitation to the number of character representation vectors to be input, and when a plurality of character representation vectors is input, data reflecting characteristics synthesizing the plurality of characters is output.

As shown in FIG. 1, the input-output operation part 110 is provided with an input-output model having a character representation space, which is a space where characteristics are represented, constructed by learning a large amount of input-output data set. Through the use of the character representation vector in the character representation space, data reflecting characteristics is output in response to the input. Further, in the case where a plurality of character representation vectors is used, data reflecting synthesized characteristics is output.

As shown in FIG. 2, in the character representation vector-calculation part 120, an input-output data set is input, and by computing in the input-output operation part 110 based on an input-output model with fixed parameters (including dimension of character representation space), a character representation vector representing the characteristics represented by the input-output data set in the character representation space is output.

In this embodiment, explanation is made in examples of handling conversation data through texts for both the input data and output data. Further, the input data may be referred to as an input sentence, and the output data as an output sentence.

### [Learning of Basic Input-Output (Large-Scale Learning)]

To activate the input-output system 100, construction of an input-output model and a character representation space in the input-output operation part 110 is initially required.

The input-output model and the character representation space in the input-output operation part 110 are constructed using conversation set data of sufficient amount to secure precision of the input-output model. Information such as user name and ID capable of identifying each speaker and respondent is applied to conversation according to the conversation set data. Normally, in constructing the input-output model, conversation set data that requires processing time of several days to about one week is required even if high-performance computation source (server provided with GPU) is used. In Embodiment 1, data including 300,000 conversation sets was prepared.

Conversation set data used in constructing the input-output operation part 110 may hereinafter be referred to as learning data or a first input-output data set.

### [Input-Output Model and Character Representation Space]

The input-output model and the character representation space of the input-output operation part 110 in Embodiment 1 are explained below, referring to FIG. 3A.

The input-output model of Embodiment 1 employs the basic structure of Encoder-Decoder model (Kyunghyun Cho, et al., Learning Phrase Representations using RNN Encoder-Decoder for Statistical Machine Translation, EMNLP2014) using RNN (Recurrent neural network) which can handle time series data, and takes into account characteristics on the output side. On the characteristics, concept of characteristics of the respondent side in the construction method of conversation model disclosed in Non-Patent Publication 1 is used, so that explanations are arbitrarily omitted and characteristic points in learning the input-output model of Embodiment 1 are primarily described herebelow.

The input-output model includes an encoder for converting an input sentence X=(x₁, x₂, . . . x_{T}) into an intermediate representation vector c of a fixed length, and a decoder for calculating an output sentence Y=(y₁, y₂, . . . y_{T′}) from the intermediate representation vector c generated by the encoder and a character representation vector uᵢ of k dimension, and including a character representation space where characteristics are represented. Incidentally, the character representation space refers to a space where each element (gender, age, dialect, etc.) representing the characteristics is reflected. The character representation space of k dimension is constructed together with construction of the input-output model (result of large-scale learning). A predetermined value is used as value k.

### [Encoder]

The encoder, when it receives the input sentence X=(x₁, x₂, . . . xₜ, . . . x_{T}), calculates a hidden state vector hₜ for each word xₜ. At this stage, as a previous hidden state vector hₜ₋₁ is considered upon calculation of the hidden state vector hₜ, the hidden state vector h_{T} that is calculated corresponding to the word x_{T} at the end of the sentence will be a vector having the meaning of the entire input sentence embedded therein. The encoder generates an intermediate representation vector c where the hidden state vector h_{T} is activated. By handing the intermediate representation vector c to the decoder, the decoder can make an output corresponding to the input sentence X. The hidden state vector hₜ in the encoder and the intermediate representation vector c are defined as below in Equation 1.

$${h}_{t} = f ( {h}_{t - 1} , {x}_{t} ) \\ c = a ( {Vh}^{〈 T 〉} ) \qquad [ Equation 1 ]$$

In Equation 1, function f is a nonlinear function, showing conversion function of LSTM in this embodiment. The function f includes various structures to determine the extent of influence by each element such as an update gate and reset gate, further provided with weight coefficient corresponding to each variable including the previous hidden state vector hₜ₋₁ and word xₜ. Since each gate is constructed only from matrix operation and activation function, learning can be made through error back propagation method to be mentioned below. Further, while identity function was used in this embodiment as function a necessary for calculating the intermediate representation vector c, activation function where output value to input value is limited within a certain range can be used, such as tan h.

### [Decoder]

A hidden state vector h_{t′} of the decoder is calculated under the influence of, not only a previous hidden state vector h_{t′-1}, but also a previous output word y_{t′-1}, the intermediate representation vector c, and the character representation vector uᵢ. The decoder then calculates an output word y_{t′} using the calculated hidden state vector h_{t′}, and the previous output word y_{t′-1}, the intermediate representation vector c, and the character representation vector uᵢ. Incidentally, the output word y_{t′} can be calculated by using only the hidden state vector h_{t′}, or using a combination of the hidden state vector h_{t′} with other elements. The hidden state vector h_{t′} of the decoder is defined as below in Equation 2.

_{|}h_{t′}=f(h_{t′-1},y_{t′-1},c,uᵢ) [Equation 2]

### [Construction of Input-Output Model]

In constructing the input-output model, the data is fixed with teacher data (learning data) up to the previous data of the output word y_{t′} to be calculated, and next output word y_{t′} is predicted, and updating of each parameter is repeated so that distribution peak of the output word y_{t′} meets the distribution of a correct word Q_{t′} of the learning data, to thereby determine an optimum solution. Concretely, the output word y_{t′} to be calculated is normalized (converted into probability) using softmax function to fit within the range between 0 and 1. Next, cross entropy error of the distribution of the correct word Q_{t′} of the learning data and the distribution of the calculated output word y_{t′} is calculated, and loss function (objective function) L′, which is a total of cross entropy errors for all words constructing the n-th output sentence of the learning data, is calculated. Subsequently, loss function L of the entire learning data (N conversation sets) is calculated. Incidentally, Adam (Adaptive Moment Estimation), one of gradient methods, is used for updating the parameters to calculate the value at which loss function L converges. Loss function L′ and loss function L are defined as below in Equation 3.

$${L}^{′} = - {\sum }_{{t}^{′} = 1}^{{T}^{′}} {Q}_{t} , log P ( {y}_{{t}^{′}} \vert {y}_{{t}^{′} - 1} , {y}_{{t}^{′} - 2} , … , {y}_{1} , c , {u}_{i} ) \\ L = \frac{1}{N} {\sum }_{n = 1}^{N} {L}^{′} \qquad [ Equation 3 ]$$

In the above Equation, y_{t′-1}, y_{t′-2}, . . . , y₁ are correct words Q_{t′-1}, Q_{t′-2}, . . . , Q₁ of the teacher data.

Incidentally, loss function L can be determined as converged when the state where variation width showing different with the previous one falls within a preset value continues for a predetermined number of times, or can be determined as converged when a number of learnings preset on epoch basis has been reached. Further, separate from the learning data, preparing verification data corresponding to the same character, determining a target value of loss function so that unknown data that does not actually exist in the learning data is input to obtain a proper result, and when the target value has been reached, the loss function L can be determined as converged.

The character representation vector uᵢ herein is an embedding vector representing properties, etc. of a speaker, namely, characteristics, where i is a subscript corresponding to an identification number of a user in the learning data. When an input model is constructed as a result of learning, a character representation space of k dimension is constructed.

Incidentally, in Embodiment 1, personal information such as dialect, registered name, age, and gender is associated with the character representation vector uᵢ, and the personal information is obtained from the conversation of each user in the learning data. Further, the character representation vector uᵢ can be associated with a unit including a plurality of elements (e.g., twenties, Akita Pref., female), not only by user basis. Furthermore, personal information can be obtained not only from conversation but from profiles, etc. of a user joining the conversation.

Since the input-output operation part 110 can construct the input-output model and the character representation space of Embodiment 1 by learning through the learning data as mentioned above, in response to the input of the input sentence and the character representation vector, an output sentence reflecting the characteristics of the input character representation vector can be output.

[Output Operation after Construction of Input-Output Model]

FIG. 3B shows an example of an input-output operation in the input-output operation part 110 after the input-output model and the character representation space are constructed.

Exemplified herein is the case where an input sentence “How's it going?” and a character representation vector of “speaker A” in the learning data were input into the input-output operation part 110.

Since “speaker A” in the learning data often uses an emoticon “(̂ω̂)” at the end of a sentence, it can be understood that an output sentence “It's wonderful (̂ω̂)” reflecting the characteristics of speaker A is output from the input-output operation part 110.

Sequence evaluation using score function is performed on each output candidate by beam search for word strings output from the decoder. The decoder is configured to output the best result therefrom. When the output of the decoder is EOS which is a specific text row indicating completion of a sentence, decoding is completed and the word string at this point is output as an output sentence corresponding to the input sentence.

The input-output operation part 110 is configured to output a character representation vector of the speaker by inputting ID, etc. corresponding to the desired speaker in the learning data, whereby a character representation vector in the learning data is obtained and can easily obtain an output sentence reflecting the characteristics in the learning data.

Action of the input-output system 100 after the input-output model and the character representation space have been constructed is explained below.

When an input sentence is input into the input-output system 100 through an input apparatus (not shown) such as a keyboard, an output sentence corresponding to the input sentence is computed in the input-output operation part 110 and is output to an external device (not shown) such as a monitor.

### [Output Reflecting Characteristics]

Action in the case where an input sentence and one character representation vector are input into the input-output system 100 of Embodiment 1 is explained below.

When an input sentence and a character representation vector are input into the input-output system 100 through an input apparatus (not shown), an output sentence reflecting characteristics corresponding to the input sentence is computed in the input-output operation part 110 and is output to an external device (not shown) such as a monitor.

### [Synthesis of Character]

Action in the case where an input sentence and a plurality of character representation vectors are input into the input-output system 100 of Embodiment 1 is explained below.

In the case where a plurality of character representation vectors are input, a plurality of character representation vectors are synthesized based on the ratio of synthesis that is preset in the input-output operation part 110.

When an input sentence and a plurality of character representation vectors are input into the input-output operation part 110 through an input apparatus (not shown) such as a keyboard, a character representation vector is synthesized based on the ratio (e.g., equal for each vector) preset in the input-output operation part 110. Next, an output sentence reflecting the synthesized characteristics corresponding to the input sentence is computed based on the synthesized character representation vector, and is output to an external device (not shown) such as a monitor.

Thus, since the input-output operation part 110 is provided with a character representation space which is a space representing characteristics as mentioned above, a character representation vector representing the synthesized characteristics can be obtained by synthesizing a vector on the character representation space.

### [Addition of Character]

Next, addition of a character by character representation vector calculation from input-output data set at a character representation vector-calculation part 120 in Embodiment 1 is explained. In Embodiment 1, with the input-output model constructed by the above-mentioned basic input-output learning (large-scale learning) fixed, a new character can be added easily by calculating a character representation vector corresponding to characteristics represented in several hundreds to thousands of conversation set data (character data set).

Fixation of the constructed input-output model herein indicates the state where each parameter of the input-output model is always fixed, thus allowing fixation of the character representation space, which may hereinafter be referred to as fixation of the input-output model and the character representation space.

Further, the input-output data set input into the character representation vector-calculation part 120 may hereinafter be referred to as a character data set or a second input-output data set. The amount of conversation sets in character data set can be several hundred to a thousand or more cases, allowing addition of characters with significantly small amount of data of about 1/1000 of several hundred thousand to several million learning data generally considered as necessary to construct an input-output model and a character space. Data required for the addition of character herein is of a level that can be processed sufficiently with processing capacity of a personal mobile terminal device as of the filing of this application. In Embodiment 1, several hundreds of conversation set data was prepared as a character data set.

When a character data set and a preset initial character representation vector are input into a fixed input-output model, the decoder calculates an output on each input at a process similar to the basic input-output learning mentioned above. In calculating the value at which loss function L converges, the loss function L being a total of cross entropy error of distribution of output calculated by the decoder relative to each input in the character data set (calculation data) and distribution of output of character data set (correct data), only the character representation vector uᵢ is updated, since parameter of the input-output model is fixed. While gradient method is used for updating the parameter, gradient g is simply defined as below in Equation 4.

$${g}_{i} = \frac{\partial L}{\partial {u}_{i}} \qquad [ Equation 4 ]$$

Gradient g is a derivative of loss function L by the character representation vector uᵢ. In Embodiment 1, gradient g is updated using Adam and updating of the character representation vector uᵢ is repeated until optimum solution of the character representation vector uᵢ is obtained.

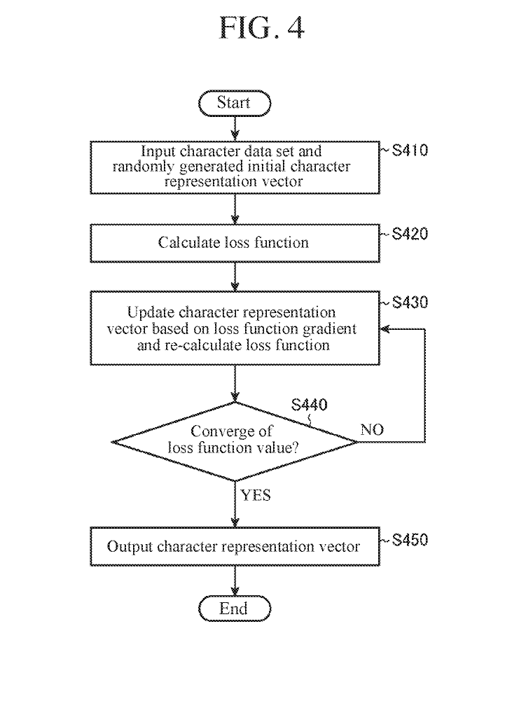

Subsequently, referring to FIG. 4, action of character representation vector calculation from an input-output data set in the character representation vector-calculation part 120 is explained.

First, an initial character representation vector, together with a character data set, is input into the character representation vector-calculation part 120 from an input part (not shown) (step S410). Incidentally, the initial character representation vector was generated randomly by random numbers.

Next, an input sentence n, which is the n-th input sentence in the character data set, and the initial character representation vector are input into the input-output operation part 110, and a calculated sentence n is obtained. Subsequently, value n is incremented from an initial value (herein 0) to the number corresponding to the final data in the character data set, to thereby calculate the value of loss function L based on cross entropy error of the calculated sentence n corresponding to the input sentence n and the output sentence n (correct sentence n) (step S420).

Next, parameter of the input-output model in the input-output operation part 110 is fixed, and in the fixed character representation space, a character representation vector corresponding to the input character data set is calculated by gradient method. Concretely, by using Adam, one of gradient methods, the character representation vector is updated using gradient g of loss function L, and loss function L is re-calculated using the updated character representation vector (step S430).

Subsequently, determination is made on whether calculated loss function L is converged or not (step S440). When loss function L is determined as not converged, moves again to step S430, and the character representation vector is updated (step S440: No→step S430). On the other hand, when loss function L is determined as converged in step S440, moves to step S450 (step S440: Yes→step S450), and the character representation vector uᵢ at this stage is output as a character representation vector corresponding to the input character data set (step S450).

Thus, the input-output model constructed by the basic input-output learning is fixed as mentioned above, the character representation vector is updated using the fixed input-output model and the character data set, and a character representation vector reflecting the characteristics represented by the character data set can be obtained. Therefore, a new character can be added easily without reconstructing the entire input-output model.

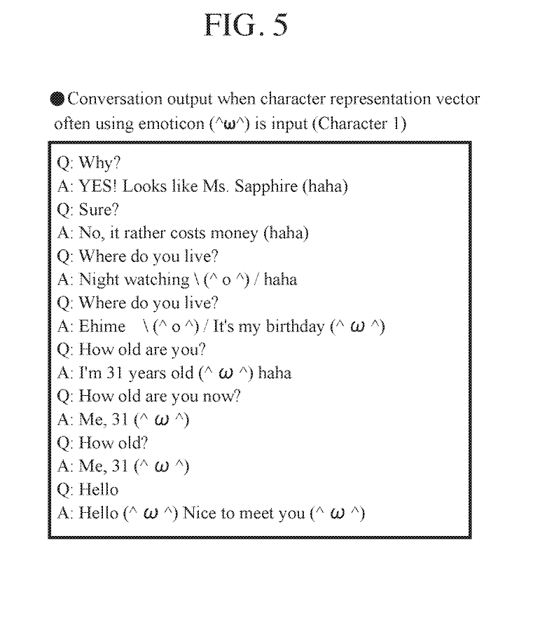

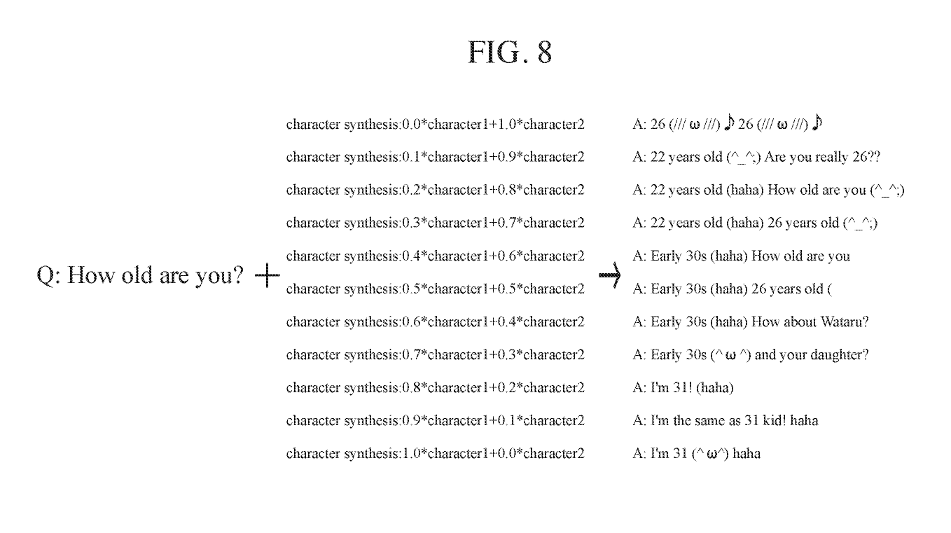

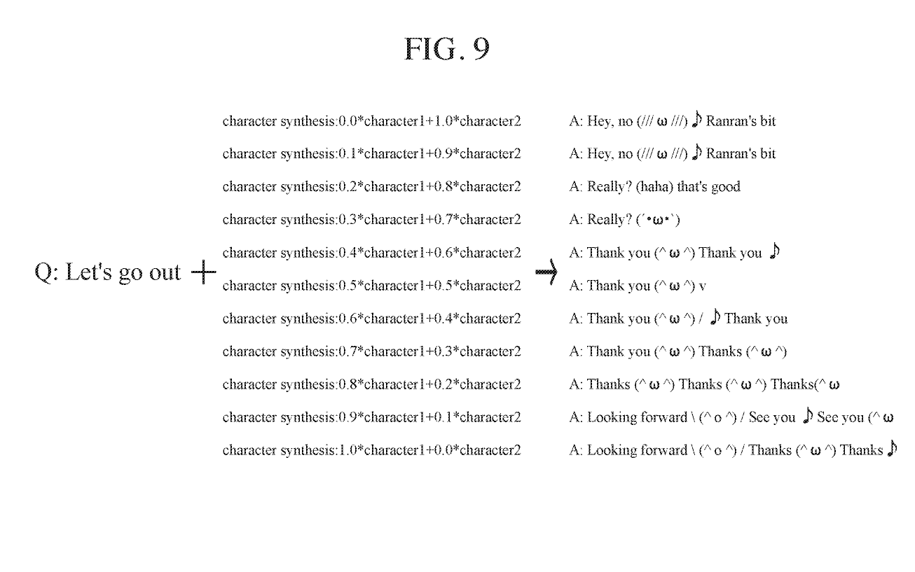

FIGS. 5 to 9 show generation of a character representation vector, an output sentence when the character representation vector is input, and an output sentence when the character representation vector is synthesized in Embodiment 1.

FIG. 5 is one example of a test result on representation of characteristics by the input-output system 100 in this embodiment. In this example, a conversation set of Character 1 often using an emoticon “(̂ω̂)” was input as a character data set in the character representation vector-calculation part 120. Next, together with the character representation vector output from the character representation vector-calculation part 120, a query (sentence represented by Q:) shown in FIG. 5 was input into the input-output operation part 110, and an output sentence for each query is according to series.

It can be understood that a reply reflecting the characteristics of Character 1 is made, often using the emoticon “(̂ω̂)”.

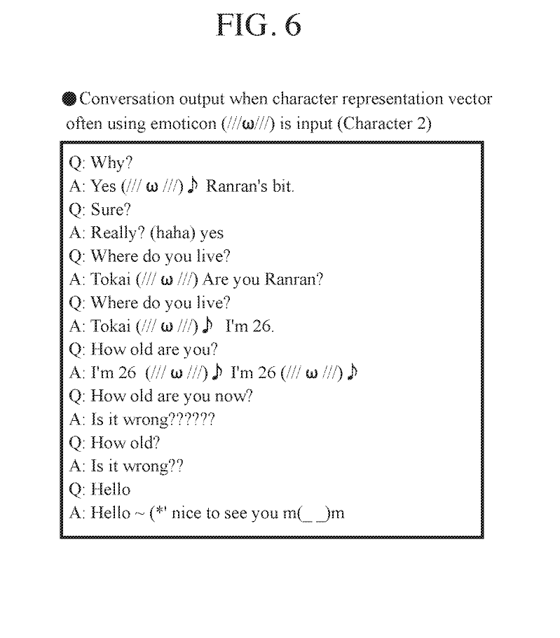

FIG. 6 shows one example of a test result on representation of characteristics by the input-output system 100 of this embodiment. In this example, a conversation set of Character 2 often using an emoticon “(///ω///)” was input as a character data set into the character representation vector-calculation part 120. Other conditions are similar to those of FIG. 5.

It can be understood that a reply reflecting the characteristics of Character 2 is made, often using the emoticon “(///ω///)”.

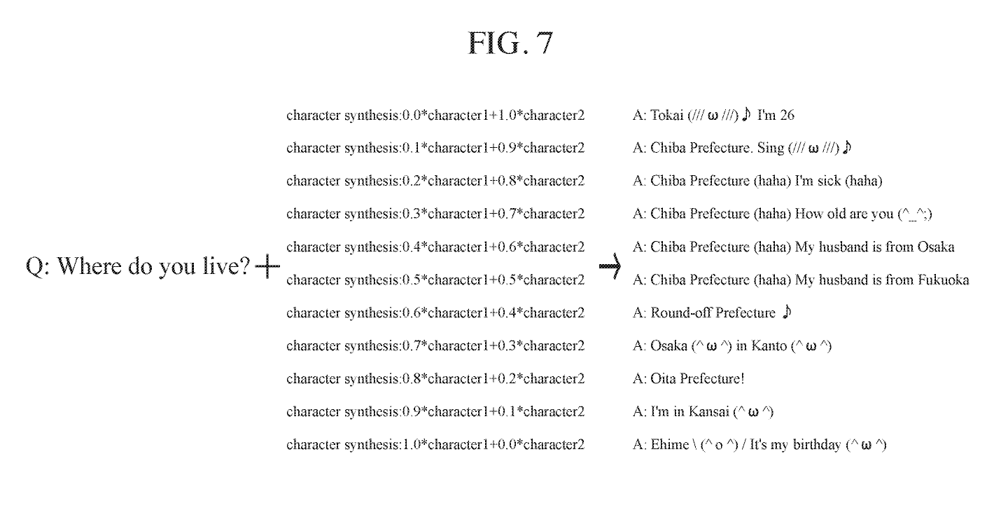

FIGS. 7 to 9 show one example of a test result on synthesis of characteristics in the input-output system 100 of this embodiment. This example shows changes in an output sentence relative to each input sentence in the case where two character representation vectors, i.e., Characters 1 and 2 generated in FIGS. 5 and 6, are input into the input-output operation part 110. Weight coefficient upon synthesizing the character representation vector was varied, 0 to 1 for Character 1, and 1 to 0 for Character 2, respectively at a pitch of 0.1.

In each result, it can be understood that not only the emoticons but also residence and age vary from Character 2 to Character 1.

### [Effect]

As mentioned above, since the input-output system 100 of Embodiment 1 is configured such that the input-output operation part 110 includes the input-output model having the character representation space, an output representing the characteristics can be made by inputting the vector on the character representation space.

Further, by only changing the character representation vector to be input, an output reflecting new characteristics can be obtained easily.

Moreover, characteristics can be synthesized by synthesizing a plurality of character representation vectors.

Furthermore, by plotting a character representation vector corresponding to each characteristic on the character representation space, a character map visualizing the characteristics on the character representation space can be created, and similarities and correlation between the characters can be visualized.

In addition, since the input-output system 100 of Embodiment 1 is configured such that the character representation vector-calculation part 120 utilizes an input-output model fixed at the input-output operation part 110 so that a character representation vector reflecting characteristics represented in the character data set can be generated, a character representation vector representing desired characteristics can be obtained easily without reconstructing the input-output operation part 110. Therefore, an output representing characteristics of a character that did not exist in the learning data for constructing the input-output operation part 110 can be made. Further, since character data sets necessary to add a character can be reduced down to about 1/1000 of data sets normally considered as necessary in conventional learning, a character can be added easily to the character representation space. Therefore, the character map in the character representation space can be enriched, and a character representation vector representing desired characteristics can be specified easily from the map. More concretely, calculation of a representative point of elements constructing the vector from multiple plots can be facilitated so that desired characteristics can be represented at a high precision.

As mentioned above, it is unnecessary to reconstruct the input-output operation part 110 for representing new characteristics in the input-output system 100 in this embodiment. Therefore, it is possible to reduce load upon control associated particularly with system during learning process. In mobile terminals such as a smartphone, load can be reduced down to an extent sufficient to calculate a character representation vector in the input-output operation part 110. Further, since a character can be extracted by using conversation set data accumulated in the mobile terminal such as a smartphone as a character data set, for example, if a server acquires various conversation set data, the server can easily collect various characters. Further, if the server acquires a character representation vector calculated at each mobile terminal, various characters can be provided easily in services using an identical character representation space.

### Embodiment 2

### [Chat System]

A chat system 2 using an input-output system 200 of Embodiment 2 is explained below.

The chat system 2 includes an input-output system 200, the chat system outputting an output sentence reflecting characteristics in response to an input sentence input from a user terminal connected through network, etc.

The input-output system 200 of Embodiment 2 is similar to the input-output system 100 of Embodiment 1 except for being constructed in a server device including a communication function, etc. and including an input-output control part 230. Thus, explanation on structures similar to Embodiment 1 is omitted.

Each action described below is independent for each user terminal connected to the input-output system 200, and the actions are carried out in parallel.

The input-output control part 230 includes the input-output control part 230 which controls an input from a user and output to the user. Further, the input-output control part 230 is configured for selecting and switching Actions 1 to 4 explained below based on a control signal, etc. input by an input part, etc. (not shown).

### [Action 1: Conversation of Preset Characters]

First, an action of performing an output reflecting preset characteristics in response to an input from a user terminal in the chat system 2 is explained.

Initially in this case, an input sentence is input from a user terminal into the input-output control part 230 via network, etc.

Next, the input-output control part 230 outputs an input sentence and a character representation vector in the character representation space in the input-output operation part 110 corresponding to a preset character to the input-output operation part 110.

Then, the input-output operation part 110 computes an output sentence corresponding to the input sentence and also reflecting characteristics of the preset character and outputs the output sentence to the input-output control part 230.

Thus, when an output sentence is input into the input-output control part 230, the input-output control part 230 transmits the output sentence reflecting preset characteristics to user terminal where the input was performed.

### [Action 2: Conversation by Characters Designated by the User]

Next, an example where the chat system 2 is configured to designate a character by UI, etc. (not shown) displayed on a user terminal is explained. In this case, the input-output control part 230 includes a correspondence table, etc. of ID, etc. of a character designated by the user, and a character representation vector in the character representation space in the input-output operation part 110.

The input-output control part 230, when an input sentence and information such as ID, etc. of the designated character are input from the user terminal, outputs a character representation vector on the character designated by the user terminal and the input sentence to the input-output operation part 110 based on the correspondence table.

Other actions are similar to Action 1 above.

### [Action 3: Conversation by Character Synthesis Designated by the User]

Next, an example where the chat system 2 is configured to synthesize a plurality of characters designated by UI, etc. (not shown) displayed on the user terminal and to perform an output reflecting the synthesized characteristics is explained. In this case, the input-output control part 230 includes a correspondence table, etc. of ID, etc. of a character designated by the user, and a character representation vector in the character representation space in the input-output operation part 110, similar to the case of Action 2 given above.

The input-output control part 230, when an input sentence and information such as ID of a plurality of designated characters are input from a user terminal, outputs character representation vectors on the plurality of characters designated by the user terminal and the input sentence to the input-output operation part 110 based on the correspondence table.

The input-output operation part 110 generates a character synthesis vector based on the plurality of character representation vectors that is input, computes an output sentence corresponding to the input sentence and reflecting the synthesized characteristics, and outputs the output sentence to the input-output control part 230.

Other actions are similar to Action 1 above.

Ratio of each character representation vector in the synthesis of the character can be configured to be designated at UI, etc. (not shown) displayed on the user terminal, or can be configured to be evenly synthesized on all characters.

While synthesis of the character representation vector was described by an example where the character synthesis vector corresponding to a plurality of characters designated at the user terminal is synthesized by the input-output operation part 110, the character synthesis vector can be configured to be synthesized at the user terminal side or at the input-output control part 230, and output to the input-output operation part 110.

### [Action 4: Reflection of Characteristics by Input-Output Data Set]

Next, an example where the chat system 2 is configured such that a character data set is input from a user terminal, and an output reflecting characteristics represented in the character data set is made.

The input-output control part 230, when a character data set is input from the user terminal, outputs the character data set to a character representation vector-calculation part 120. The character representation vector-calculation part 120 calculates a character representation vector corresponding to the character data set that is input, and outputs the character representation vector to the input-output control part 230.

When the character representation vector is input from the character representation vector-calculation part 120 into the input-output control part 230, the input-output control part 230 thereafter outputs the character representation vector corresponding to the character data set that is input together with the input sentence to the input-output operation part 110 until update, etc. of the character is instructed.

Then the input-output operation part 110 computes an output sentence corresponding to the input sentence and reflecting characteristics corresponding to the character data set, and outputs the above to the input-output control part 230.

Other actions are similar to Action 1 above.

While an example where the input-output system 200 includes the character representation vector-calculation part 120 was described herein, the character representation vector-calculation part 120 can be provided at the user terminal side. By the chat system 2 having such a structure, a chat reflecting characteristics from input-output data sets collected by the user him/herself can be enjoyed without considering data transmission cost, etc. Further, a highly interesting system can be provided, such as by the chat system 2 collecting character representation vectors calculated at the user terminal side, response acting as a chat member can be made.

While an example of the chat system 2 where the character data set is input by a user has been described herein, character data sets can be configured to be obtained through various methods. Examples are given below.

The input-output system 200 can be configured, based on instructions, etc. from the user terminal, to collect conversations by the users in a chat service, etc., input the conversations in the character representation vector-calculation part 120 as a character data set, and calculate a character representation vector representing the user. The instruction from the user terminal can include, for example, an instruction to collect data necessary as a character data set, when such data has been accumulated.

Moreover, the input-output system 200 can be configured to output a preset query (query on profile, etc.) to a user, obtain a reply to the query, and calculate a character representation vector representing the user with the pair of the query and the reply as an input-output data set.

By the chat system 2 including such a structure, a chat system 2 capable of performing an output representing the characteristics of the user can be constructed.

Further, the chat system 2 can be configured to use a character representation vector for each user calculated from the character data set obtained from profiles, etc. as mentioned above in an automatic matching, etc. of chat users.

Namely, the chat system 2 is configured to define similarity for each user by distances, etc. of a character representation vector on a character representation space, and to match users with close similarities.

By the chat system 2 including such a structure, matching users with close characteristics is possible as users with close character representation vectors are considered as having similar characteristics.

As mentioned above, in the chat system 2 of Embodiment 2, a chat reflecting preset characteristics can be enjoyed.

Further, a chat reflecting characteristics designated by the user can be enjoyed.

Moreover, a chat reflecting characteristics synthesizing a plurality of characters designated by the user can be enjoyed.

Furthermore, a chat reflecting characteristics corresponding to a character data set input by the user can be enjoyed.

This invention was explained as above with reference to the embodiments. While each structure of each embodiment was described on examples constructed on general purpose computers, all or a part of each structure can be constructed with a dedicated hardware, etc.

While the input-output system 100 in Embodiment 1 or 2 was described on examples using sentences, namely, text data, for both input and output, there is no limitation thereto, which can be media data such as images, sounds, and videos, or combinations thereof.

Concrete examples include learning an image corresponding to a sentence to generate a picture resembling a particular artist (character) based on the sentence, and generating Japanese translation resembling a particular translator (character) based on an English expression.

While the input-output model of the input-output operation part 110 of Embodiment 1 or 2 was described on an example using an input-output model using Encoder-Decoder model using RNN, there is no limitation thereto, as long as the input-output model has a character representation space.

While the characteristics corresponding to the character representation vector in Embodiment 1 or 2 were described on examples using personal information, etc. such as dialect, registered name, age, and gender, any element can be used as long as the element can be corresponded to the input-output data set, and arbitrary elements such as digitized emotion and impression can be used.

While Embodiment 1 or 2 was described with an example where, in the case where a plurality of character representation vectors is input into the input-output operation part 110, each characteristic is synthesized based on ratio that is preset within the input-output operation part 110, the input-output operation part 110 can be configured to accept an input on synthesis ratio of each character representation vector together with a plurality of character representation vector. In this case, the character synthesis vector is generated based on the input ratio, and an output sentence reflecting the synthesized character representation vector is output.

While the synthesis of the character representation vector in the input-output operation part 110 in Embodiment 1 or 2 was described on examples of synthesis of two characters by input of two character representation vectors, any number of character representation vectors can be input. Further, while synthesis of the character representation vector was described regarding the case of simple sum by weight, any function that can reflect weighing can be used.

While updating of the character representation vector in step S430 in the character representation vector-calculation part 120 of Embodiment 1 or 2 was explained regarding the case of using Adam, any method can be used as long as the method is an optimizing method using gradient of loss function.

Convergence of loss function value in step S440 can be configured such that the character representation vector is updated for a number of times sufficient for converging, and moves to step S450 when a predefined number of updating is completed.

While Embodiment 2 was explained regarding an example where the input-output system 200 includes the input-output control part 230, the input-output control part 230 can be provided at the user terminal side.

This invention is not limited to the embodiments given above. Various modifications that may be understood by those skilled in the art can be made on the structures and actions of this invention within the scope of not departing from the gist of this invention.

### DESCRIPTION OF REFERENCE NUMERALS

100, 200 . . . input-output system
110 . . . input-output operation part
120 . . . character representation vector-calculation part
2 . . . chat system
230 . . . input-output control part

1. An input-output system comprising:
an input-output operation part,
wherein the input-output operation part includes an input-output model including a character representation space which is a space where characteristics, constructed by learning an input-output data set, are represented,
a character representation vector which is a vector representing characteristics in the character representation space and input data are input into the input-output operation part, and
the input-output operation part computes and outputs output data corresponding to the input data reflecting the characteristics based on the input-output model and the character representation space.

2. The input-output system according to claim 1, further comprising a character representation vector-calculation part,
a character data set which is an input-output data set for extracting characteristics is input into the character representation vector-calculation part, and
the character representation vector-calculation part calculates a character representation vector corresponding to the character data set based on a computed result on the character data set in the input-output model and the character representation space fixed in the input-output operation part.

3. The input-output system according to claim 1, wherein:
input data and a plurality of character representation vectors are input into the input-output operation part,
the input-output operation part generates a character synthesis vector which is a vector where characteristics represented in each of the plurality of character representation vectors are synthesized, and computes and outputs output data corresponding to the input data and reflecting characteristics synthesized based on the character synthesis vector.

4. A chat system for performing a conversation reflecting characteristics between users,
wherein the chat system includes the input-output system according to claim 1,
the character representation vector based on a preset character is input into the input-output system, and
output data corresponding to input data from the user and reflecting characteristics of the preset character is output.

5. A chat system for performing a conversation reflecting characteristics between users,
the chat system including the input-output system according to claim 2,
the character data set designated by the user is input into the input-output system, so that the character representation vector reflecting characteristics corresponding to the character data set is calculated, input data from the user and the character representation vector are input into the input-output operation part, and output data corresponding to the input data from the user is output.

6. A chat system for performing a conversation reflecting characteristics between users,
the chat system including the input-output system according to claim 3,
a plurality of character representation vectors based on a plurality of characters designated by the user is input into the input-output system, and
output data corresponding to input data from the user reflecting characteristics synthesizing the plurality of characters designated by the user is output.

7. An information processing apparatus, including:
an input-output operation part including an input-output model including a character representation space which is a space where characteristics constructed by learning a first input-output data set is represented, and which computes and outputs output data corresponding to the input data reflecting the characteristics based on input data and a character representation vector that is input, which is a vector representing characteristics in the character representation space; and
a character representation vector-calculation part into which a second input-output data set is input, and which calculates a character representation vector reflecting characteristics corresponding to the second input-output data set based on computed result in the input-output model and the character representation space fixed in the input-output operation part.

8. A non-transitory computer-readable recording medium in which an input-output program is recorded, wherein the program is for executing, in an input-output system including an input-output operation part including an input-output model having a character representation space which is a space where characteristics constructed by learning an input-output data set are represented, the steps of:
inputting input data and a character representation vector which is a vector representing characteristics in the character representation space into the input-output operation part;
computing, by the input-output operation part, output data corresponding to the input data reflecting the characteristic based on the input-output model and the character representation space; and
outputting the output data.

9. A non-transitory computer-readable recording medium in which a data structure of a character is recorded,
wherein the data structure for use in an input-output system including an input-output operation part comprises:
a character representation space which is a space representing characteristics constructed by learning an input-output data set,
wherein the data structure of a character is used for processing of the input-output operation part including an input-output model including the character representation space in which:
a character representation vector which is a vector representing characteristics in the character representation space and input data are input into the input-output operation part, and an output data corresponding to the input data reflecting the characteristics based on the input-output model and the character representation space is computed.

10. A computer-implemented method comprising the steps of:
inputting input data and a character representation vector which is a vector representing characteristics in a character representation space into an input-output operation part which comprises an input-output model having the character representation space where characteristics, constructed by learning an input-output data set, are represented;
computing, by the input-output operation part, output data corresponding to the input data reflecting the characteristic based on the input-output model and the character representation space; and
outputting the output data.

11. The input-output system according to claim 2, wherein:
input data and a plurality of character representation vectors are input into the input-output operation part,
the input-output operation part generates a character synthesis vector which is a vector where characteristics represented in each of the plurality of character representation vectors are synthesized, and computes and outputs output data corresponding to the input data and reflecting characteristics synthesized based on the character synthesis vector.

12. A chat system for performing a conversation reflecting characteristics between users,
wherein the chat system includes the input-output system according to claim 2,
the character representation vector based on a preset character is input into the input-output system, and
output data corresponding to input data from the user and reflecting characteristics of the preset character is output.

13. A chat system for performing a conversation reflecting characteristics between users,
wherein the chat system includes the input-output system according to claim 3,
the character representation vector based on a preset character is input into the input-output system, and
output data corresponding to input data from the user and reflecting characteristics of the preset character is output.

14. A chat system for performing a conversation reflecting characteristics between users,
wherein the chat system includes the input-output system according to claim 11,
the character representation vector based on a preset character is input into the input-output system, and
output data corresponding to input data from the user and reflecting characteristics of the preset character is output.
